(19) United States
(12) Patent Application Publication
(10) Pub. No.: US 2012/0032784 A1
(43) Pub. Date: Feb. 9, 2012

(54) Magnetic Sensing Bar Assembly with Multiple Functions

(76) Inventor: Chih-Sheng Wang, Kaohsiung City (TW)

(21) Appl. No.: 12/849,851

(22) Filed: Aug. 4, 2010

(51) Int. Cl. H04Q 5/22

(52) U.S. Cl. 340/10.1

(57) ABSTRACT

A magnetic sensing bar assembly includes a RFID unit, an EM unit, a top covering paper and a bottom covering paper. The RFID unit and the EM unit are sandwiched between the top covering paper and the bottom covering paper. The magnetic sensing bar assembly has an elongate thin shape. Thus, the magnetic sensing bar assembly combines the function of an EM sensing system and a RFID sensing system, thereby enhancing the versatility of the magnetic sensing bar assembly. In addition, the magnetic sensing bar assembly has an elongate thin shape so that the magnetic sensing bar assembly can be placed in a book to have a hidden effect. Further, the magnetic sensing bar assembly has a shorter length so that the magnetic sensing bar assembly has a is available for an article having a smaller size.

### BACKGROUND OF THE INVENTION

1. Field of the Invention

The present invention relates to a sensing device and, more particularly, to a magnetic sensing bar assembly.

2. Description of the Related Art

A conventional EM sensing system 11 in accordance with the prior art shown in FIG. 4 comprises an elongate substrate 111 and a plurality of magnetized pieces 112 mounted on the elongate substrate 111. Thus, when the EM sensing system 11 is bonded onto a merchandise, such as a book and the like, the EM sensing system 11 can provide an identification function. However, the EM sensing system 11 does not have an information storage function.

A conventional RFID sensing system 12 in accordance with the prior art shown in FIG. 5 comprises a label paper 121, a RF chip 122 mounted on the label paper 121 and an antenna 123 mounted on the label paper 121 and connected with the RF chip 122. Thus, when the RFID sensing system 12 is bonded onto a merchandise, such as a book and the like, the identification information stored in the RF chip 122 is transmitted by the wireless waves of the antenna 123. However, the RFID sensing system 12 has a larger volume and cannot be hidden easily so that the RFID sensing system 12 is often bonded onto the outside of the merchandise and is easily torn by a person intentionally.

### BRIEF SUMMARY OF THE INVENTION

In accordance with the present invention, there is provided a magnetic sensing bar assembly, comprising a RFID (radio frequency identification) unit, an EM (electromagnetic) unit abutting the RFID unit, a top covering paper abutting the EM unit and a bottom covering paper abutting the RFID unit.

The RFID unit and the EM unit are sandwiched between the top covering paper and the bottom covering paper. The RFID unit includes a RF (radio frequency) chip and an antenna connected with the RF chip. The antenna of the RFID unit has a strip shape. The EM unit includes an elongate substrate and a plurality of magnetized pieces mounted on the elongate substrate. The magnetized pieces of the EM unit are spaced from each other. The EM unit contains a partial profile of the antenna of the RFID unit. The top covering paper has a first side abutting the EM unit and a second side provided with a top release paper which is detachably mounted on the top covering paper. The top covering paper is preferably a sticker. The bottom covering paper has a first side abutting the RFID unit and a second side provided with a bottom release paper which is detachably mounted on the bottom covering paper. The bottom covering paper is preferably a sticker. The magnetic sensing bar assembly has an elongate thin shape. The RFID unit is sandwiched between the EM unit and the bottom covering paper. The EM unit is sandwiched between the RFID unit and the top covering paper.

The primary objective of the present invention is to provide a magnetic sensing bar assembly having multiple functions.

According to the primary advantage of the present invention, the magnetic sensing bar assembly combines the function of an EM sensing system and a RFID sensing system, thereby enhancing the versatility of the magnetic sensing bar assembly.

According to another advantage of the present invention, the magnetic sensing bar assembly has an elongate thin shape so that the magnetic sensing bar assembly can be placed in a book to have a hidden effect, thereby preventing the magnetic sensing bar assembly from being torn by a person intentionally so as to achieve an antitheft function.

According to a further advantage of the present invention, the magnetic sensing bar assembly has a shorter length so that the magnetic sensing bar assembly has a is available for an article having a smaller size.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a magnetic sensing bar assembly in accordance with the preferred embodiment of the present invention.

FIG. 2 is an exploded perspective view of the magnetic sensing bar assembly as shown in FIG. 1.

FIG. 3 is a front cross-sectional view of the magnetic sensing bar assembly as shown in FIG. 1.

FIG. 4 is a perspective view of a conventional EM sensing system in accordance with the prior art.

FIG. 5 is a perspective view of a conventional RFID sensing system in accordance with the prior art.

### DETAILED DESCRIPTION OF THE INVENTION

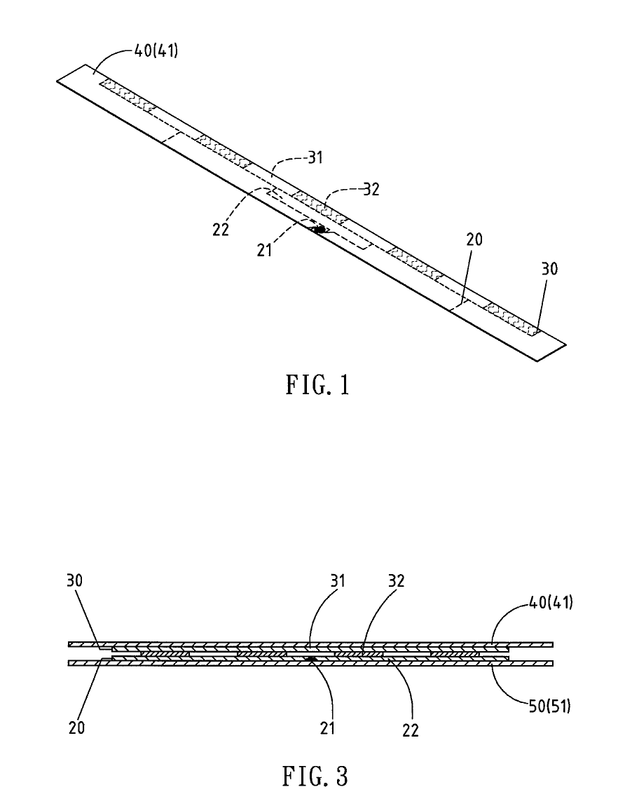

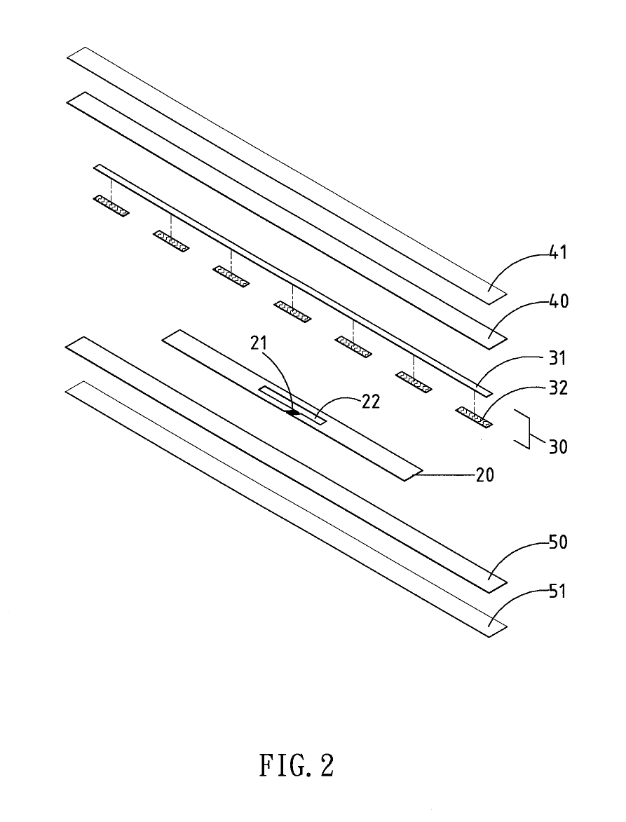

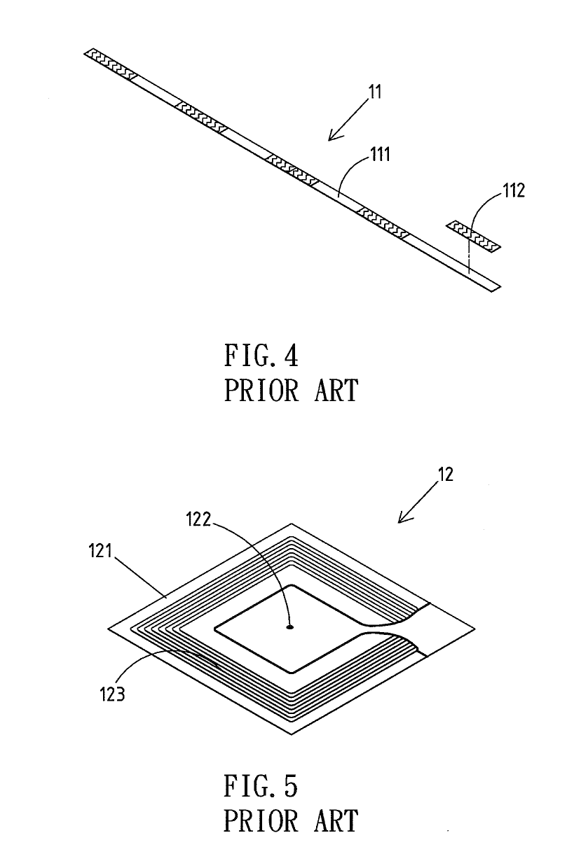

Referring to FIGS. 1-3, a magnetic sensing bar assembly in accordance with the preferred embodiment of the present invention comprises a RFID (radio frequency identification) unit 20, an EM (electromagnetic) unit 30 abutting the RFID unit 20, a top covering paper 40 abutting the EM unit 30 and a bottom covering paper 50 abutting the RFID unit 20. The RFID unit 20 and the EM unit 30 are sandwiched between the top covering paper 40 and the bottom covering paper 50.

The RFID unit 20 includes a RF (radio frequency) chip 21 and an antenna 22 connected with the RF chip 21. The antenna 22 of the RFID unit 20 has a strip shape. The antenna 22 of the RFID unit 20 is a super high frequency antenna that is made of an aluminum alloy. The RFID unit 20 is sandwiched between the EM unit 30 and the bottom covering paper 50.

The EM unit 30 includes an elongate substrate 31 and a plurality of magnetized pieces 32 mounted on the elongate substrate 31. The magnetized pieces 32 of the EM unit 30 are spaced from each other. The EM unit 30 is sandwiched between the RFID unit 20 and the top covering paper 40. The EM unit 30 contains a partial profile of the antenna 22 of the RFID unit 20.

The top covering paper 40 has a first side abutting the EM unit 30 and a second side provided with a top release paper 41 which is detachably mounted on the top covering paper 40. The top covering paper 40 is preferably a sticker.

The bottom covering paper 50 has a first side abutting the RFID unit 20 and a second side provided with a bottom release paper 51 which is detachably mounted on the bottom covering paper 50. The bottom covering paper 50 is preferably a sticker.

In the preferred embodiment of the present invention, the magnetic sensing bar assembly has an elongate thin shape.

Accordingly, the magnetic sensing bar assembly combines the function of an EM sensing system and a RFID sensing system, thereby enhancing the versatility of the magnetic sensing bar assembly. In addition, the magnetic sensing bar assembly has an elongate thin shape so that the magnetic sensing bar assembly can be placed in a book to have a hidden effect, thereby preventing the magnetic sensing bar assembly from being torn by a person intentionally so as to achieve an antitheft function. Further, the magnetic sensing bar assembly has a shorter length so that the magnetic sensing bar assembly has a is available for an article having a smaller size.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A magnetic sensing bar assembly, comprising:
a RFID (radio frequency identification) unit;
an EM (electromagnetic) unit abutting the RFID unit;
a top covering paper abutting the EM unit; and
a bottom covering paper abutting the RFID unit.

2. The magnetic sensing bar assembly of claim 1, wherein the RFID unit and the EM unit are sandwiched between the top covering paper and the bottom covering paper.

3. The magnetic sensing bar assembly of claim 1, wherein
the RFID unit includes a RF (radio frequency) chip and an antenna connected with the RF chip;
the antenna of the RFID unit has a strip shape.

4. The magnetic sensing bar assembly of claim 1, wherein
the EM unit includes an elongate substrate and a plurality of magnetized pieces mounted on the elongate substrate;
the magnetized pieces of the EM unit are spaced from each other.

5. The magnetic sensing bar assembly of claim 1, wherein the EM unit contains a partial profile of the antenna of the RFID unit.

6. The magnetic sensing bar assembly of claim 1, wherein the top covering paper has a first side abutting the EM unit and a second side provided with a top release paper which is detachably mounted on the top covering paper.

7. The magnetic sensing bar assembly of claim 1, wherein the top covering paper is a sticker.

8. The magnetic sensing bar assembly of claim 1, wherein the bottom covering paper has a first side abutting the RFID unit and a second side provided with a bottom release paper which is detachably mounted on the bottom covering paper.

9. The magnetic sensing bar assembly of claim 1, wherein the bottom covering paper is a sticker.

10. The magnetic sensing bar assembly of claim 1, wherein the magnetic sensing bar assembly has an elongate thin shape.

11. The magnetic sensing bar assembly of claim 1, wherein
the RFID unit is sandwiched between the EM unit and the bottom covering paper;
the EM unit is sandwiched between the RFID unit and the top covering paper.
